(19) United States
(12) Patent Application Publication
(10) Pub. No.: US 2018/0341772 A1
(43) Pub. Date: Nov. 29, 2018

(54) NON-TRANSITORY COMPUTER-READABLE STORAGE MEDIUM, MONITORING METHOD, AND INFORMATION PROCESSING APPARATUS

(71) Applicant: FUJITSU LIMITED, Kawasaki-shi (JP)

(72) Inventor: Soya Aoyama, Fuchu (JP)

(73) Assignee: FUJITSU LIMITED, Kawasaki-shi (JP)

(21) Appl. No.: 15/976,214

(22) Filed: May 10, 2018

(30) Foreign Application Priority Data
May 24, 2017 (JP) 2017-102940

(51) Int. Cl. G06F 21/56; G06F 21/55

(52) U.S. Cl. CPC G06F 21/566; G06F 21/552; G06F 21/554

(57) ABSTRACT

A non-transitory computer-readable storage medium storing a program that causes a computer to execute processing, the processing including acquiring a first integrity level of a first process from an operating system at a first timing, acquiring a second integrity level of the first process from the operating system at a second timing after the first timing, comparing the second integrity level with the first integrity level, and outputting an alert that notifies a malware attack upon a determination that the second integrity level is higher than the first integrity level.

### CROSS-REFERENCE TO RELATED APPLICATION

This application is based upon and claims the benefit of priority of the prior Japanese Patent Application No. 2017-102940, filed on May 24, 2017, the entire contents of which are incorporated herein by reference.

### FIELD

The embodiment discussed herein is related to a non-transitory computer-readable storage medium, a monitoring method, and an information processing apparatus.

### BACKGROUND

In the related art, there is a monitoring technology that an alert is an output by detecting malware that becomes a threat such as computer viruses, worms, and spyware that illegally infect equipment in the network. For example, attacks due to the malware to be monitored have authority escalation that escalates their own authority to perform higher authority processes or the like than originally given. This authority escalation is known to extend a function so that the user can use the specific function temporarily in a state where a user without authority to use for a specific function is logged in. Anti-virus software based on pattern matching using a virus definition database is known for such monitoring of the malware related to authority escalation.

Japanese Laid-open Patent Publication No. 2010-218089 is example of the related art.

### SUMMARY

According to an aspect of the invention, a non-transitory computer-readable storage medium storing a program that causes a computer to execute processing, the processing including acquiring a first integrity level of a first process from an operating system at a first timing, acquiring a second integrity level of the first process from the operating system at a second timing after the first timing, comparing the second integrity level with the first integrity level, and outputting an alert that notifies a malware attack upon a determination that the second integrity level is higher than the first integrity level.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a functional configuration example of an information processing apparatus according to an embodiment;

FIG. 2 is an explanatory diagram explaining an example of a process database;

FIG. 3 is a flowchart illustrating an operation example of the information processing apparatus according to the embodiment; and

FIG. 4 is a block diagram illustrating a hardware configuration example of the information processing apparatus according to the embodiment.

### DESCRIPTION OF EMBODIMENT

However, in the related art, there is a problem that it is difficult to detect abnormality caused by unknown malware related to authority escalation. For example, in malware such as authority escalation, there are some variants that are derived from many different types and include unknown malware that is not included in a virus definition database.

In one aspect, it is an object to provide a monitoring program, a monitoring method, and an information processing apparatus capable of detecting the unknown malware related to the authority escalation.

Hereinafter, with reference to the drawings, the monitoring program, the monitoring method, and the information processing apparatus according to the embodiment will be described. In the embodiment, the same reference numerals are given to the components having the same function, and duplicate explanation will be omitted. The monitoring program, the monitoring method, and the information processing apparatus to be described in the following embodiment is merely an example, and the embodiments are not limited. In addition, the following each embodiment may be suitably combined within a range not inconsistent.

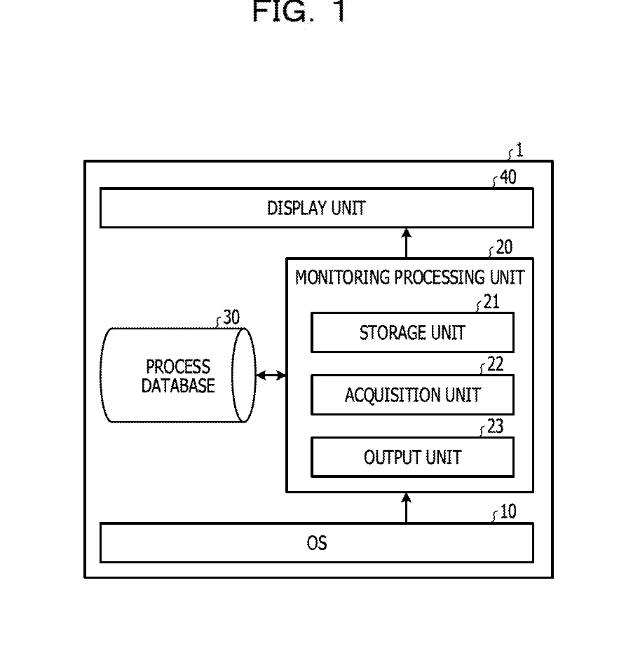

FIG. 1 is a block diagram illustrating a functional configuration example of the information processing apparatus according to the embodiment. For example, an information processing apparatus 1 according to the embodiment is a computer such as a personal computer (PC), and a tablet terminal. As illustrated in FIG. 1, the information processing apparatus 1 includes an OS (Operating System) 10, a monitoring processing unit 20, a process database 30, and a display unit 40.

The information processing apparatus 1 realizes a function as the monitoring processing unit 20 by executing a monitoring program under the execution environment of the OS 10. The monitoring processing unit 20 performs a monitoring process for detecting the malware that is a threat such as a computer virus, worm, and spyware illegally infecting an apparatus and outputting an alert.

Specifically, the monitoring processing unit 20 monitors a process by an application program or the like, not a pattern matching type malware detection utilizing a virus definition database or the like, and detects the malware by grasping various events caused by operating the malware.

The OS 10 such as Windows (registered trademark) manages the generation, execution, and extinction of processes accompanying execution of a program. In addition, the OS 10 has two access controls of “access control by access permission” and “access control by integrity level” as a control for accessing an object (file, registry, process, or the like). The “access control by access permission” is access control set for each user (group). The “access control by integrity level” is access control set for each generated process.

The integrity level for each process is determined at the time of process creation, and the level is not changed during the process. In addition, basically, except for some exceptions, the integrity level is not higher than a parent process of a generation source.

However, in a case where there is an attack due to the malware related to the authority escalation, an abnormality event in which the integrity level of the process changes from a low state to a high state (authority changes stronger), occurs. Therefore, the monitoring processing unit 20 performs detection of the malware by detecting the abnormality event in which the integrity level of the process changes from the low state to the high state.

Specifically, the monitoring processing unit 20 outputs the alert indicating an attack due to the malware according to detection that a detection target satisfies that the integrity level is (target 1)>(target 2) in a first case, a second case, and a third case as (target 1) and (target 2).

First Case

(target 1): a current integrity level of the process

(target 2): an integrity level at the time of last acquisition of the process

Second Case

(target 1): a current integrity level of the parent process of the process

(target 2): an integrity level at the time of last acquisition of the parent process of the process

Third Case

(target 1): the current integrity level of the process

(target 2): the current integrity level of the parent process of the process

By detecting an abnormality event, the information processing apparatus 1 can also detect unknown malware according to the authority escalation, and not registered in the virus definition database or the like.

The monitoring processing unit 20 includes a storage unit 21, an acquisition unit 22, and an output unit 23. The storage unit 21 acquires the current integrity level of each process from the OS 10, and stores the acquired current integrity level of the process in the process database 30.

The process database 30 is a database of managing information for each process. The process database 30 stores information according to the process the identification information (process ID and parent process ID) of identifying a process and the parent process in the process and the integrity level of the process in each process. That is, the process database 30 is an example of the storage unit.

Specifically, the storage unit 21 acquires a certain process and/or the parent process of the integrity level of the process by using an application programming interface (API) according to the OS 10. Then, the storage unit 21 stores identification information (process ID and parent process ID) identifying its process and the parent process, and the acquired integrity level in the process database 30 in the process in which the integrity level is acquired.

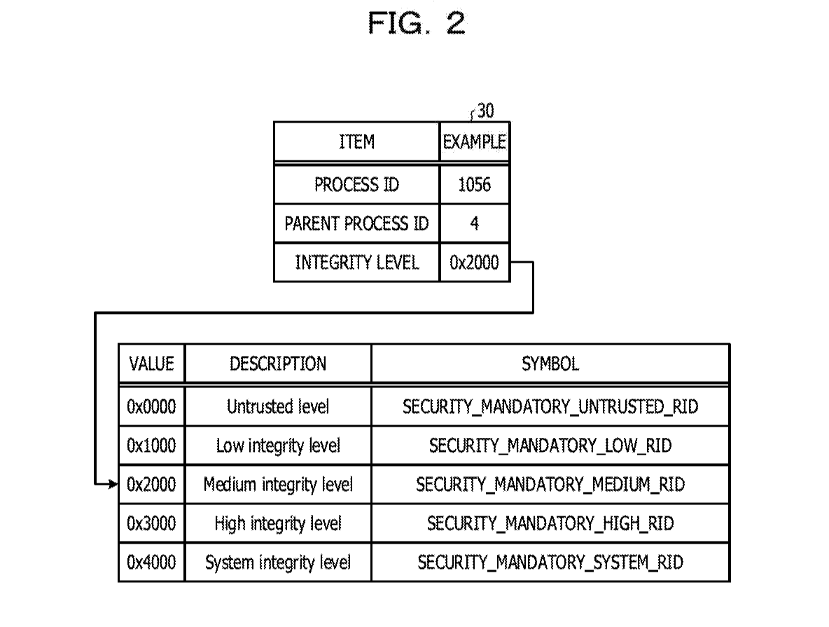

FIG. 2 is an explanatory diagram explaining an example of the process database 30. As illustrated in FIG. 2, the process database 30 stores the process ID identifying the process, the parent process ID indicating the parent process of the process, and the integrity level of the process in each process. In the illustrated example, in the process of the process ID “1056”, the process ID of the parent process is “4”. Therefore, by referring data of the process ID “4” by the process database 30, it is possible to confirm a matching example level of the parent process.

In the matching example level, as an example, one value (Value) of five steps of “0x0000” to “0x4000” in which “Description”, “Symbol”, and the like are defined is stored. Regarding the height of the integrity level, it is assumed that the level gradually increases from “0x0000” and “0x4000”. In this case, “0x4000” is the highest level (corresponding to the strongest authority).

In the illustrated example, for the process with the process ID “1056”, the integrity level of the third row from the bottom corresponding to the value of “0x2000” is set. Specifically, “Medium integrity level” is set in the “Description” and the integrity level of “SECURITY_MANDATORY_MEDIUM_RID” is set in the “Symbol”.

The acquisition unit 22 acquires the previous integrity level of a previously stored process and/or the previous integrity level of the parent process of the process from the process database 30. Specifically, before the storage unit 21 acquires the integrity level of the process and the acquired integrity level is stored in the process database 30, the acquisition unit 22 acquires the integrity level of the process from the process database 30 and the parent process of the integrity level of the process.

The output unit 23 detects an abnormality event in which a state of the integrity level of the process is changed from a low state to a high state based on the current integrity level of the process and the current integrity level of the parent process of the process acquired by the storage unit 21, and the integrity level at the time of the last acquisition of the process and the parent process at the time of the last acquisition of the integrity level of the process acquired by the acquisition unit 22. Therefore, the output unit 23 outputs the alert indicating the attack due to the malware according to the detection of the abnormality event.

Specifically, the output unit 23 outputs the alert according to detection ((target 1)>(target 2) in first case) that the current integrity level of a certain process (first process) rises relative to the previous integrity level of the process. In addition, the output unit 23 outputs the alert according to detection ((target 1)>(target 2) in second case) that the current integrity level of the parent process of a certain process (first process) rises relative to the previous integrity level of the parent process of the process. In addition, the output unit 23 outputs the alert according to detection ((target 1)>(target 2) in third case) that the current integrity level of a certain process (first process) rises relative to the current integrity level of the parent process of the process.

For example, the alert output from the output unit 23 includes, for example, a pop-up message, a balloon display, and the like on the display unit 40. In addition, the output unit 23 may output the alert by transmitting a mail to a predetermined address through a communication unit (not illustrated). In addition, the output unit 23 may output the alert by recording a log file (not illustrated). A user can recognize the attack due to the malware by confirming these outputs.

The output of the alert may indicate contents corresponding to each abnormality event in the first case, the second case, and the third case. For example, for the abnormality event of (target 1)>(target 2) in the first case, the alert that “since the current integrity level of a predetermined process rises relative to the previous integrity level of the process and the attack due to the malware is suspected” or the like is output. With this, a user can recognize the abnormality event in the first case, the second case, or the third case.

The display unit 40 performs display output such as display. For example, the display unit 40 displays the alert output from the process database 30 on a display or the like. With this, users can confirm the contents of the alerts.

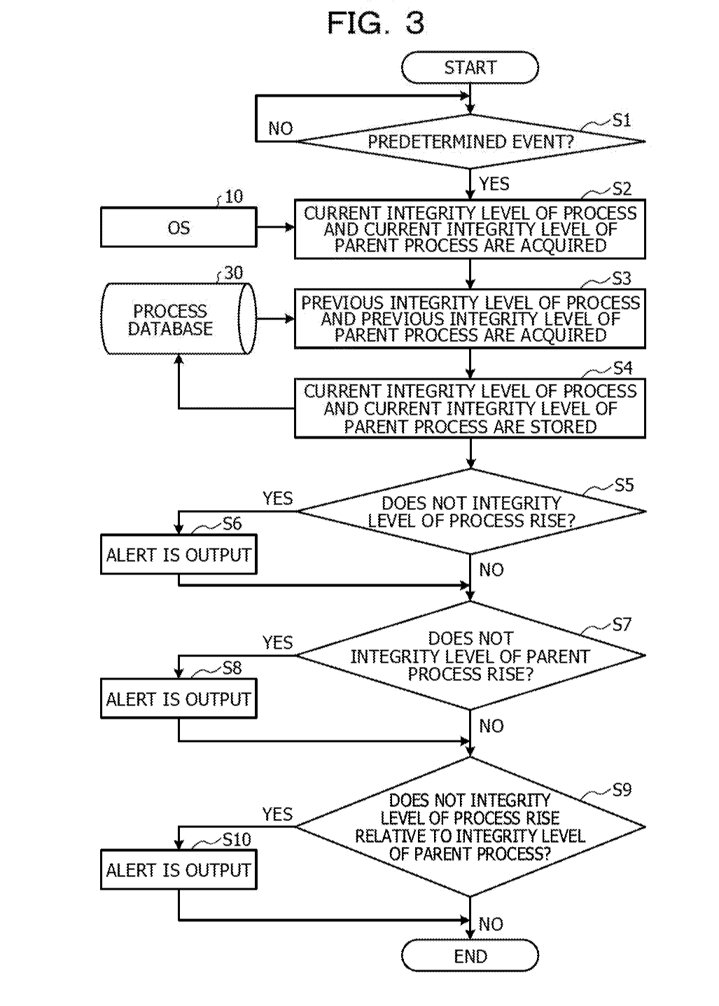

FIG. 3 is a flowchart illustrating an operation example of the information processing apparatus 1 according to the embodiment. As illustrated in FIG. 3, when starting the process, the storage unit 21 determines whether or not a predetermined event occurs by monitoring an event in the OS 10 (S1), and in a case where the event does not occur (S1: NO), the process is waited. For an event to be a determination target, any event such as process creation, DLL (Dynamic Link Library) loading, file access, and TCP/IP (Transmission Control Protocol/Internet Protocol) communication may be used. By monitoring such an event, the storage unit 21 detects a timing (occurrence of event) at which the process operates to perform various processes, and the process starts.

In a case where the event occurs (S1: YES), the storage unit 21 acquires the current integrity level of the process and the current integrity level of the parent process from the OS 10 through an API (S2). The process in which the integrity level is acquired through the API may be all the processes managed by the OS 10, or may be limited to those related to the event occurred in S1.

Next, the acquisition unit 22 acquires the integrity level of each process stored in the process database 30, that is, the previous integrity level of a previously stored process and the previous integrity level of the parent process (S3). Then, the storage unit 21 stores the integrity level acquired in S2, that is, the current integrity level of the process and the current integrity level of the parent process in the process database 30 (S4).

Next, the output unit 23 compares the current integrity level of the process and the previous integrity level having the same process ID, and determines whether the integrity level of the process is not risen (S5). That is, the output unit 23 determines presence or absence of an event of (target 1)>(target 2) in the first case.

In a case where it rises (S5: YES), the output unit 23 outputs the alert indicating the attack due to the malware (S6). Specifically, the output unit 23 outputs the alert that “since the current integrity level of a predetermined process rises relative to the previous integrity level of the process and the attack due to the malware is suspected” or the like.

In a case where it is not risen (S5: NO), the output unit 23 compares the current integrity level of the parent process and the previous integrity level having the same process ID, and determines whether or not the integrity level of the parent process is not risen (S7). That is, the output unit 23 determines presence or absence of an event of (target 1)>(target 2) in the second case.

In a case where it rises (S7: YES), the output unit 23 outputs the alert indicating the attack due to the malware (S8). Specifically, the output unit 23 outputs the alert that “since the current integrity level of the parent process of a predetermined process rises relative to the previous integrity level of the parent process of the process and the attack due to the malware is suspected” or the like.

In a case where it is not risen (S7: NO), the output unit 23 compares the integrity level of the process in a parent-child relationship with the process ID and the parent process ID, and determines whether the integrity level of the process is not risen relative to the integrity level of the parent process (S9). That is, the output unit 23 determines presence or absence of an event of (target 1)>(target 2) in the third case.

In a case where it rises (S9: YES), the output unit 23 outputs the alert indicating the attack due to the malware (S10). Specifically, the output unit 23 outputs the alert that “since the integrity level of a predetermined process rises relative to the parent process of the integrity level of the process and the attack due to the malware is suspected” or the like.

As described above, the storage unit 21 of the information processing apparatus 1 acquires the current integrity level and/or the current integrity level of the parent process of the first process in a certain process (first process) from the OS 10 and stores the acquired result in the process database 30. The acquisition unit 22 of the information processing apparatus 1 acquires the previous integrity level of the first process previously stored from the process database 30 and/or the previous integrity level of the parent process of the first process. The output unit 23 of the information processing apparatus 1 outputs the alert indicating the attack due to the malware according to detection that the acquired current integrity level of the first process rises relative to the previous integrity level of the first process. In addition, the output unit 23 outputs the alert indicating the attack due to the malware according to detection that the acquired current integrity level of the parent process of the first process rises relative to the parent process of the previous integrity level of the first process. With this, for example, the information processing apparatus 1 can detect unknown malware related to the authority escalation that is not registered in the virus definition database or the like.

In addition, when detecting a predetermined event such as process creation, DLL loading, file access, and TCP/IP communication, the storage unit 21 acquires the current integrity level of the process and/or the current integrity level of the parent process of the process related to a predetermined event. With this, the information processing apparatus 1 can detect the abnormality event in which a state of the integrity level of the process relating to a predetermined event is changed from the low state to the high state.

In addition, the output unit 23 outputs the alert indicating the attack due to the malware according to detection that the acquired current integrity level of the first process rises relative to the acquired current integrity level of the parent process of the first process. With this, the information processing apparatus 1 can detect the attack due to the malware according to the abnormality event in the third case.

Each configuration element of each device illustrated in the drawings is not inevitably and physically configured as illustrated in the drawings. That is, the specific form of distribution/integration of each device is not limited to those illustrated in the drawings, and all or a part thereof can be configured by being functionally or physically dispersed and integrated in arbitrary units according to various loads and usage situations.

In addition, all or some of the part of various process functions executed in the information processing apparatus 1 may be on a CPU (or microcomputer such as MPU and microcontroller unit (MCU)). In addition, it goes without saying that all or some of the various process functions may be executed on a program analyzed and executed in the CPU (or microcomputer such as MPU and MCU) or on hardware using a wired logic. In addition, the various process functions performed by the information processing apparatus 1 may be performed by being cooperated with a plurality of computers through cloud computing.

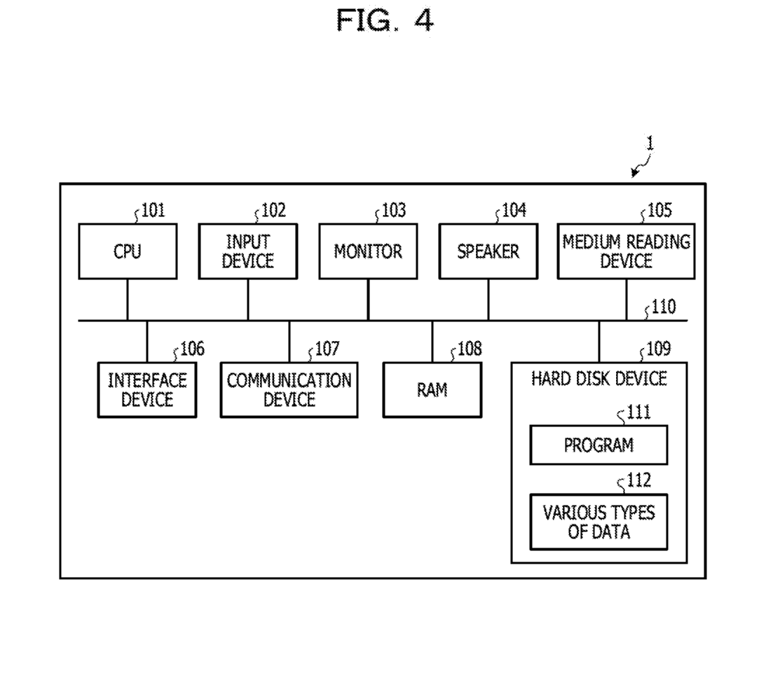

However, the various processes described in the above embodiment can be realized by executing a program prepared in advance by a computer. Therefore, in the following, an example of a computer (hardware) that executes a program having the same function as the above embodiment will be described. FIG. 4 is a block diagram indicating a hardware configuration example of the information processing apparatus 1 according to the embodiment.

As illustrated in FIG. 4, the information processing apparatus 1 includes a CPU 101 that performs various arithmetic processes, an input device 102 that receives data inputs, a monitor 103, and a speaker 104. In addition, the information processing apparatus 1 includes a medium reading device 105 that reads a program or the like from a storage medium, an interface device 106 that connects with various devices, and a communication device 107 that communicates with an external device by wired or wireless connection. In addition, the information processing apparatus 1 includes a RAM 108 and a hard disk drive 109 that temporarily store various types of information. In addition, respective units (101 to 109) within the information processing apparatus 1 are connected to a bus 110.

In the hard disk drive 109, a program 111 for performing various processes such as the storage unit 21, the acquisition unit 22, and the output unit 23 is stored in the monitoring processing unit 20 described in the above-described embodiment. In addition, various types of data 112 referred by the program 111 are stored in the hard disk drive 109. For example, the input device 102 receives inputs of operation information from an operator of the information processing apparatus 1. For example, the monitor 103 displays various screens to be operated by the operator. The interface device 106 is connected to, for example, a print device or the like. The communication device 107 is connected to a communication network such as a local area network (LAN), and exchanges various types of data with external devices through the communication network.

The CPU 101 performs various processes by reading the program 111 stored in the hard disk drive 109 and expanding and executing the program 111 in the RAM 108. The program 111 may not be stored in the hard disk drive 109. For example, the program 111 stored in a storage medium which can be read by the information processing apparatus 1 may be read and executed. For example, the storage medium which can be read by the information processing apparatus 1 corresponds to a portable recording medium such as a CD-ROM, a DVD disk, and a universal serial bus (USB) memory, and a semiconductor memory such as a flash memory and a hard disk drive. In addition, this program 111 may be stored in a device connected to a public line, the Internet, a LAN, or the like, and the information processing apparatus 1 may read and execute the program 111 from these.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable storage medium storing a program that causes a computer to execute processing, the processing comprising:
acquiring a first integrity level of a first process from an operating system at a first timing;
acquiring a second integrity level of the first process from the operating system at a second timing after the first timing;
comparing the second integrity level with the first integrity level; and
outputting an alert that notifies a malware attack upon a determination that the second integrity level is higher than the first integrity level.

2. The non-transitory computer-readable storage medium according to claim 1, wherein the processing further comprises:
storing, in a storage device, information that indicates the acquired first integrity level upon the acquiring the first integrity level.

3. The non-transitory computer-readable storage medium according to claim 1, wherein the processing further comprises:
acquiring a third integrity level of a parent process of the first process from the operating system at the first timing;
acquiring a fourth integrity level of the parent process from the operating system at the second timing; and
comparing the fourth integrity level with the third integrity level; and
outputting the alert upon a determination that the fourth integrity level is higher than the third integrity level.

4. The non-transitory computer-readable storage medium according to claim 3, wherein the processing further comprises:
comparing the second integrity level with the fourth integrity level; and
outputting the alert upon a determination that the second integrity level is higher than the fourth integrity level.

5. The non-transitory computer-readable storage medium according to claim 1, wherein
the acquiring the second integrity level is performed upon a detection of a predetermined event.

6. The non-transitory computer-readable storage medium according to claim 1, wherein
the predetermined event is one of a process creation, a Dynamic Link Library loading, a file access and a Transmission Control Protocol/Internet Protocol communication.

7. A monitoring method executed by a computer, the monitoring method comprising:
acquiring a first integrity level of a first process from an operating system at a first timing;
acquiring a second integrity level of the first process from the operating system at a second timing after the first timing;
comparing the second integrity level with the first integrity level; and
outputting an alert that notifies a malware attack upon a determination that the second integrity level is higher than the first integrity level.

8. An information processing apparatus comprising:
a memory; and
a processor coupled to the memory and the processor configured to execute a processing, the processing including:
acquiring a first integrity level of a first process from an operating system at a first timing;
acquiring a second integrity level of the first process from the operating system at a second timing after the first timing;
comparing the second integrity level with the first integrity level; and
outputting an alert that notifies a malware attack upon a determination that the second integrity level is higher than the first integrity level.
